(19) United States
(12) Patent Application Publication
(10) Pub. No.: US 2021/0011435 A1
(43) Pub. Date: Jan. 14, 2021

(54) STRAP OBJECT AND/OR MOVEMENT COMPRISING A PHOTOVOLTAIC CELL

(71) Applicant: Ronda AG, Lausen (CH)

(72) Inventors: Matteo Keller, Arbedo (CH); Evan Mossier, Lausanne (CH); Dominique Solignac, Penthalaz (CH); Peter Kaeuper, Lausanne (CH); Nathanaël Rossi, Morges (CH)

(21) Appl. No.: 16/982,106

(22) PCT Filed: Mar. 19, 2019
(86) PCT No.: PCT/IB2019/052204

§ 371 Date: Sep. 18, 2020

(30) Foreign Application Priority Data
Mar. 21, 2018 (CH) CH00384/18

(51) Int. Cl. G04C 10/02; H02S 40/20; G04G 21/02; G04G 17/04

(52) U.S. Cl. CPC G04C 10/02; H02S 40/20; G04B 3/04; G04G 17/04; G04G 21/02

(57) ABSTRACT

A strap object, preferably a strap watch provided with a photovoltaic cell. The photovoltaic cell is preferably arranged on a button and/or the crown of the watch. In another form of embodiment, the cell is arranged inside the housing, and the crown and/or the button is provided with a waveguide allowing the light to be transported to the cell. In another form of embodiment, a movement is provided with a photovoltaic cell.

### TECHNICAL FIELD

The present invention relates to a wristlet object and/or a control center for a wristlet object comprising at least one photovoltaic cell. The invention relates also to a wristlet object and/or a control center that is likely to be arranged with a shaft comprising an electrical cable and/or a passage for the light.

### STATE OF THE ART AND PROBLEMS THE INVENTION SEEKS TO ADDRESS

Timepieces, such as wristwatches, comprising photovoltaic cells are known per se. In most cases, the photovoltaic cell is arranged on the dial of the watch. Another possibility is to arrange the photovoltaic cell on the case or even on a part of the wristlet.

Given the increasing number of functionalities of a wristwatch that demand energy, and with that also the increasing quantity of electrical energy consumed, it becomes necessary to optimize the energy recovery. One objective of the invention is to maximize the surface area covered by the photovoltaic cells.

In the case where the wristwatch is worn with a long sleeve, such as a shirt for example, the photovoltaic cells of the state of the art are greatly disrupted, or even blocked. One objective of the invention is to propose a location for the incorporation of the cell that makes it possible to increase the exposure to light radiation.

It should also be noted that the arrangement of photovoltaic cells on the case or the dial risks adversely affecting the esthetics of the watch. One objective of the invention is to provide a photovoltaic energy source which has no impact on the design of the case and/or of the dial of the watch.

Also, it would be desirable for the movement manufacturers to be also able to offer a source of electricity based on photovoltaics. Currently, it is only the watch manufacturers who can offer watches comprising photovoltaic cells, because the latter do not form part of the movement. A manufacturer who manufactures only movements to supply them to the producers of watches cannot provide a watch comprising a photovoltaic cell, because in this case it has to be provided from the very design of the final watch, that is to say the combination of photovoltaic cell (on the dial or case) and the transportation of the current to the inside of the watch, to the movement, where both the cells and the consumers of electrical energy are located. One objective of the invention is to implement a movement which makes it possible to incorporate a photovoltaic current source or function which can be used in combination with any watch case and/or external parts. One objective is to implement a movement which makes it possible to incorporate a photovoltaic current function even if the dial and/or the case is not provided with a photovoltaic cell.

The objectives described above apply equally to any type of wristlet object, for example connected watches.

In particular, connected watches generally have a touch display over all the top surface of the watch which makes the incorporation of a photovoltaic cell difficult. One of the objectives is to make it possible to implant a photovoltaic cell without reducing the size of the display.

### SUMMARY OF THE INVENTION

In one aspect, the invention relates to a wristlet object comprising a protruding element comprising a solar cell, a lens and/or a mirror.

In one aspect, the invention relates to a movement comprising a photovoltaic cell connected to a control center, to the interior of the control center and/or to the surface of the control center.

In one aspect, the invention relates to a wristlet object comprising a case, a photovoltaic cell being arranged inside the case.

In one aspect, the invention relates to a wristlet object comprising at least one protruding element linked by a shaft to the control center, said shaft being provided with an electrical cable and/or with a passage for the light.

In one aspect, the invention relates to a wristlet object comprising a protruding element provided with a lens.

In one aspect, the invention relates to a wristlet object comprising a case comprising a light passage, for example comprising case an aperture allowing light to reach the interior of the case.

In one aspect, the invention relates to a wristlet object comprising at least one protruding element provided with a mirror.

In one aspect, the invention relates to a wristlet object comprising at least one protruding element, said wristlet object comprising at least one photovoltaic cell, characterized in that said at least one photovoltaic cell is arranged: on said protruding element and/or on or in a control center and/or in the case of said wristwatch.

In one aspect, the invention relates to a wristlet object comprising a protruding element, for example a crown and/or at least one button, emerging from the case of the wristlet object and linked by a shaft to the control center of the wristlet object, characterized in that said shaft comprises an electrical cable and/or a passage for the light.

In one aspect, the invention relates to a wristlet object and/or a control center likely to be arranged in a shaft comprising an electrical cable and/or a passage for the light.

In one aspect, the invention relates to a control center for a wristlet object, the control center being arranged to be housed in a case of a wristlet object, said control center comprising a photovoltaic cell.

In one aspect, the invention relates to a control center for a wristlet object comprising a shaft arranged to link the control center to a protruding element, said protruding element being arranged to be able to be actuated by a user wearing the wristlet object comprising the control center, characterized in that said shaft comprises an electrical cable and/or a passage for the light.

In one aspect, the invention relates to a control center for a wristlet object comprising a shaft arranged to link the control center to a protruding element, said shaft being arranged to be connected to a protruding element comprising at least one photovoltaic cell.

A control center for a wristlet object comprising a shaft arranged to link the control center to a protruding element, said shaft being arranged to be provided with an electrical cable and/or with a passage for the light.

Other aspects of the invention and preferred embodiments are defined in the claims and in the description below.

### DESCRIPTION OF THE DRAWINGS

The features and the advantages of the invention will emerge more clearly on reading a description of a preferential embodiment, which is in no way limiting, given purely by way of example, and made with reference to the schematic figures in which:

FIGS. 1A to 1C are top views of wristwatches (without the wristlet) comprising photovoltaic cells arranged on the lateral surface of the crown (FIGS. 1A and 1B) and/or on the lateral surface of at least one button (FIGS. 1B and 1C) of the wristwatch, in accordance with an embodiment of the invention.

FIGS. 2A to 2C are side views of wristwatches (without the wristlet) comprising photovoltaic cells arranged on the head of the crown (FIGS. 2A and 2B) and/or on the head of at least one button (FIGS. 2B and 2C) of the wristwatch, in accordance with an embodiment of the invention.

FIGS. 3A to 3C are perspective views of wristwatches (without the wristlet) comprising photovoltaic cells arranged on the head of the crown (FIGS. 3A and 3C) and/or on the head of at least one button (FIGS. 3A and 3C) of the wristwatch, in accordance with an embodiment of the invention.

FIGS. 4A to 4C are perspective views of wristwatches (without the wristlet) comprising lenses arranged on the head of the crown (FIGS. 4A and 4C) and/or on the head of at least one button (FIGS. 4B and 4C) of the wristwatch, in accordance with an embodiment of the invention.

FIGS. 5A and 5B are top views of wristwatches (without the wristlet) comprising a shaft provided with an optical fiber and a photovoltaic cell incorporated in the movement and arranged to receive the light transmitted through the optical fiber, in accordance with an embodiment of the invention.

### DETAILED DESCRIPTION OF THE PREFERRED EMBODIMENTS

The present invention relates to wristlet objects, preferably wristwatches, comprising at least one function requiring electrical energy. Preferably, the object comprises a photovoltaic cell. The expressions “a photovoltaic cell” and “the photovoltaic cell” also cover the plural form. These expressions are not considered to be limited by a particular number of cells and can refer to several photovoltaic cells linked in parallel or in series, for example, or to cells operating independently of one another. In the present description, the term “cell” is sometimes used to refer to one or several “photovoltaic cells”.

In one embodiment, the wristlet object is chosen from a smartwatch, a connected watch, and a wristlet object arranged or intended to measure physiological, environmental and/or medical parameters. The wristlet objects arranged to measure physiological, medical and/or parameters can be arranged to detect the pulse (a pulse meter), the heart rate, the perspiration, health markers, vital signs, respiration, for example. The wristlet object can comprise a tensiometer, a depth gauge, navigation systems (location system), for example.

In a preferred embodiment, the wristlet object comprises a time base. Preferably, the time base is a quartz tuning fork.

In a preferred embodiment, the wristlet object is a quartz wristwatch.

In one embodiment, the wristlet object comprises a control center. The control center comprises one or more mechanical and/or electronic elements allowing the wristlet object to function. In the case of a wristwatch, the control center is preferably the movement of the watch. Preferably, the movement is a quartz movement.

In one embodiment, the control center can comprise one or more of the following elements: a data processing unit (CPU), one or more memories, a time base, a microprocessor, a sensor, an interface, a wireless module. One or more of the abovementioned elements can make it possible for the wristlet object to function.

Preferably, the control center of the wristlet object comprises a cell, preferably a rechargeable cell. Preferably, the rechargeable cell is arranged to store the electrical energy generated by the photovoltaic cell. In one embodiment, the control center comprises another rechargeable element, for example a storage battery or a capacitor, in addition to or instead of said rechargeable cell.

In one embodiment, the wristlet object comprises one or more functions that operate using electrical energy. For example, in the case of a quartz watch, the latter requires energy to keep oscillating. Other functions requiring electrical energy are the light that makes it possible to illuminate the dial and/or the display, one or more sensors, the display, for example a touchscreen or a digital display, the emission of signals, the capturing of signals, the memories. The wristlet object of the invention can comprise a microchip, a chip, a microprocessor, etc. At least some or all of these elements are preferably located in the control center. In one embodiment, the wristlet object is equipped to implement computer programs and/or firmware, for example.

Preferably, the wristlet object comprises at least one protruding element. Preferably, the protruding element emerges from a lateral surface of the case of the wristlet object, for example from the lateral surface of the middle of the wristlet object.

In a preferred embodiment, the protruding element is chosen from actuation members intended to be actuated by a user. The members can be intended to make it possible to activate one or more functions of the wristlet object, to set the wristlet object, for example to set the time, and/or to parameterize or program one or more functions of the wristlet object.

In one embodiment, the protruding element or elements are chosen from a crown and/or one or more buttons. This embodiment applies preferably when the wristlet object is a watch. However, other wristlet objects can also comprise one or more buttons, even a crown.

The protruding element or elements, for example the button and/or the crown, preferably forms part of the external elements of the wristlet object, that is to say it is visible from the outside and designed to be actuated by a user or wearer of the wristlet object.

Generally, the protruding element or elements emerge from the lateral surface of the case 2, in particular from the middle of the wristlet object. A hole and/or cylindrical hollows are preferably arranged in the middle to house the protruding element. In the case of a crown, it can be framed by horns and/or bulges of the middle, in order to prevent the crown from catching, for example on a fabric or on a thread, for example.

In the case where the invention relates to a control center, for example a movement, the control center is preferably provided with at least one shaft arranged to link the protruding element to the control center, once the latter is placed in the case of the wristlet object. In the absence of a shaft, the control center is preferably arranged to be connected to such a shaft.

Preferably, the protruding element or elements are intended to emerge from a lateral surface of the case of the wristlet object. Preferably, the case and/or more specifically the middle of the wristlet object comprises a hole through which the shaft linking the protruding element passes. In the case of a crown of a wristwatch, the shaft is generally threaded over at least a part of its length.

In the case of a button, the wristlet object can comprise one or more, for example two, buttons. In the embodiments shown in the figures, two buttons are present, arranged on either side of the crown of a wristwatch. Preferably, the protruding element or elements, for example the buttons and the crown, extend in one and the same plane parallel to the dial.

In one embodiment, said button or buttons are push-pieces, intended to be actuated by being depressed, preferably by the finger of a wearer of the wristlet object.

The figures show a watch 1 comprising the case 2. The protruding elements are produced in the form of a crown 3 and of two buttons 4 arranged on either side of the crown on the lateral surface of the case and/or of the middle 6.

The wristlet object comprises at least one photovoltaic cell 5. In the figures, the photovoltaic cells are shown in black.

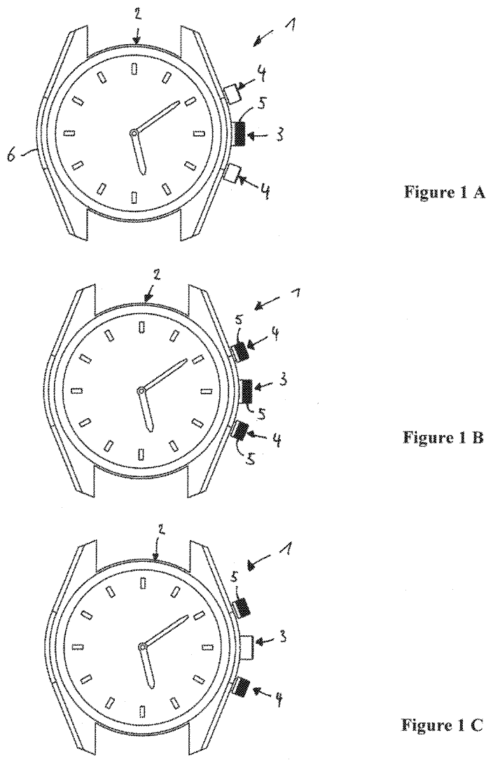

In the embodiments shown in FIGS. 1A, 1B, a photovoltaic cell 5 is arranged on the lateral surface of the crown. This is the surface which is often provided with a flute. The cell is therefore preferably arranged on a tube or hollow cylinder surrounding the crown or a part thereof. The cell can itself form a tube. The cell can replace the flute. The cell can be covered with a transparent piece or layer that makes it possible to actuate the crown by grasping the cell on the crown.

In one embodiment, cells (or partial cells) are arranged in flutes present on the lateral surface of the protruding element, preferably of the crown, preferably in hollows or interstices of the flute (not shown).

The cell is preferably connected to the protruding element, for example the crown, so as to be secured thereto. In one embodiment, and more generally, the cell can be dismantled and can be separated from the protruding element in order to be replaced. This applies preferably independently of the location of the cell, on the lateral surface or the head of the protruding element, and even in the case of a cell arranged on or in the control center.

In the embodiments shown in FIGS. 1B and 1C, a photovoltaic cell is arranged on the lateral surface of each of the two buttons 4. In this case also, the cell is preferably at least partly tubular, and/or is preferably arranged on a tube.

It is also possible to have a single button provided with a cell, or to provide a wristlet object comprising two buttons of which only one is provided with a cell.

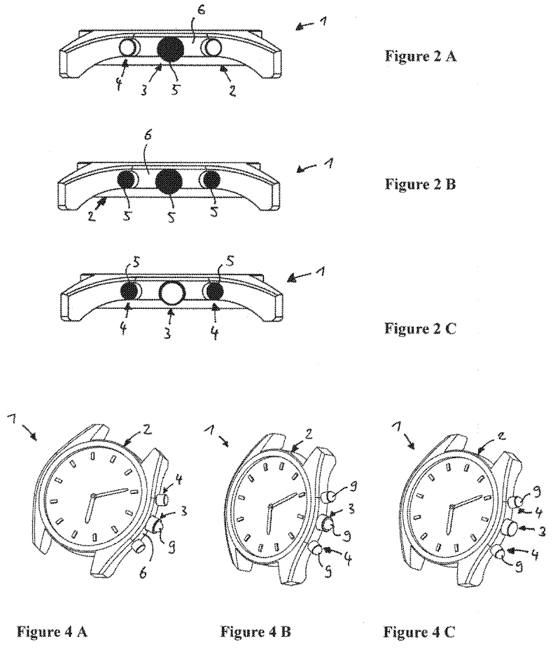

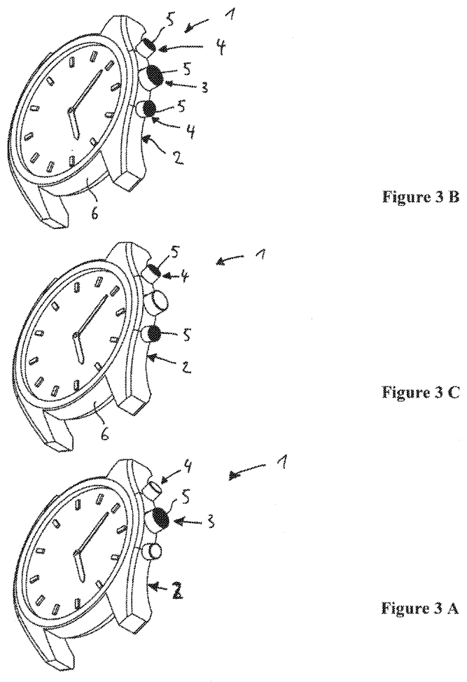

In one embodiment, said at least one photovoltaic cell is positioned at the head of the protruding element, for example at the head of the crown and/or of a button. Examples of this embodiment are shown in FIGS. 2A-2C and 3A-3C. In the examples shown in FIGS. 2A, 2B, 3A and 3B, cells 5 are arranged on the head of the crown, that is to say on the surface at the distal end of the crown. This surface can be arranged to be flat or slightly domed. The cell preferably appears substantially circular in the side view of FIGS. 2A and 2B.

In FIGS. 2A, 3B, 3A and 3C, the two buttons 4 are provided with a cell arranged on the head of the buttons, that is to say on the preferably circular, possibly domed, surface forming the distal end of the button. This is also the actuation surface: a user who actuates the button will push on the distal surface of the button in order to be able to depress it and thus to trigger the functionality associated with the button.

The distal end of the protruding element, for example of the button and/or of the crown, is generally a free end, because it is the other end, the proximal end, which is housed in or driven into the case of the wristlet object.

The invention also covers that cells are arranged both on the head and the lateral surface of at least one protruding element.

In a preferred embodiment, a cell is arranged at the head of the crown and on the lateral surface of at least one button. In this case, it is possible to leave free the surfaces used by a user to actuate the crown and the button respectively. The crown is generally actuated by grasping the lateral surface between the thumb and the index finger and by turning, and the button is generally actuated by pushing on the surface at the head of the button.

Preferably, the current generated by the cell is transported by one or more cables inside the case to the movement. In one embodiment, the shaft of the protruding element comprises one or more electrical cables, arranged to transport the current generated by said photovoltaic cell to the control center. In one embodiment, the center of the shaft of the protruding element, for example of said crown, is hollow and/or the shaft comprises a tube, arranged to allow an electrical cable to be guided inside said shaft.

In the context of the present description, the expression “electrical cable” covers also wires, rods, pegs, pins, tubes and other conductive longitudinal structures that can be used to transport current. Preferably, the protruding element comprises at least one of these structures, preferably two, in order to be able to transport the electrons to the control center and to return to the cell (or positively-charged holes to the case), in particular to the storage element arranged in the case/control center. Preferably, the one or two cables are electrically insulated and/or include an insulator, in addition to a conductive material.

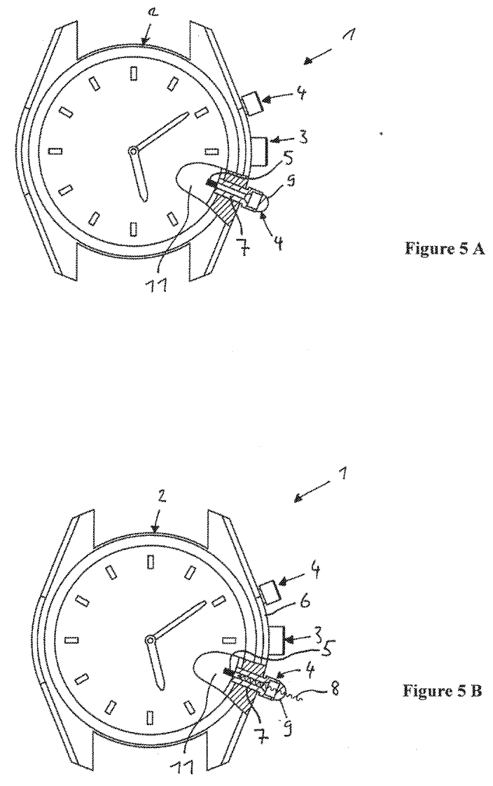

In accordance with another embodiment, said photovoltaic cell 5 is arranged inside the control center and/or the case 2 of the wristlet object. Preferably, the protruding element 3, 4 comprises a shaft 7 comprising a passage for the light. For example, an optical fiber is arranged in said shaft. FIGS. 4A to 5B illustrate this embodiment.

In one embodiment, the passage for the light is a material and/or an arrangement facilitating and/or promoting the transport of the light, for example a light guide. “Light” is understood to mean any type of electromagnetic radiation, preferably a radiation that can be used by a photovoltaic cell to generate electricity. The light passage can comprise one or more mirrors or other light-reflecting or light-scattering structures. When the path to be taken by the light is short, the passage for the light can comprise an aperture, as will be described in detail later hereinbelow. In a preferred embodiment, the light passage comprises or consists of an optical fiber. More generally, the light passage comprises a waveguide.

In one embodiment, a passage for the light is arranged to transport the light which reaches the protruding element 3, 4 to the interior of the control center 11 and/or of the case 2 to said photovoltaic cell 5 arranged on or in said control center or case.

In one embodiment, the wristlet object comprises one or more shafts 7 for linking the protruding element 3, 4 to the control center 11, characterized in that said shaft 7 comprises a tube and/or a hollow in which an electrical cable and/or a passage for the light is arranged.

In one embodiment, the control center of the invention is arranged to be able to be provided with the protruding element and/or with a shaft arranged to link the control center to the protruding element.

In FIGS. 5A and 5B, the button 4 comprising an optical fiber is shown in longitudinal cross section. In this view, the shaft 7 is visible. The shaft 7 comprises a hollow and/or is tubular, and the optical fiber is arranged in the hollow. The shaft itself passes through the case through a hole in the middle 6 of the case 2 in a conventional manner.

Generally, the shaft 7 is arranged to link the protruding element, for example the crown and/or the button, to the control center, for example to the movement, through an aperture in the case, in particular in the middle.

In one embodiment, the light passage is an aperture in the case allowing light to pass and to reach the cell arranged in/on the control center and/or in the case. In this embodiment, a protruding element may be absent.

A photovoltaic cell 5 is preferably arranged in or on the control center 11 so as to be exposed to the light transmitted from the outside through a passage for the light, for example from the distal end of the protruding element. The cell 5 preferably faces the proximal (internal) end of the shaft 7 and/or of the passage for the light. In the embodiment shown in FIGS. 5A and 5B, the cell is arranged on the outer surface of the movement and faces the shaft of the button 4.

The invention also covers the possibility of the cell being arranged more inside the control center 11. In this case, a passage for the light, for example an optical fiber cable, is arranged to go beyond the proximal end of the shaft 7 and to enter into the control center 11 to guide the light up to the cell.

In another embodiment, the cell is arranged not on or in the control center, for example the movement, but more generally in the case. For example, the cell can be arranged in an internal wall of the case. In this case, the passage for the light is arranged accordingly to take the light to the cell, for example by passing first via the shaft 7 as described above, if appropriate.

In the same way as described in the example of the button, the shaft of the crown 3 can be provided with a passage for the light, and a cell 5 can be arranged in the control center or in the case to receive (or be illuminated by) the light which passes through said passage for the light.

In one embodiment, the wristlet object 1 comprises a mirror and/or a lens 9 arranged on said protruding element 3, 4, preferably on the head of the protruding element.

In another embodiment, a mirror and/or a lens 9 arranged on an aperture in the case and/or the middle of the wristlet object.

In one embodiment, the protruding element is provided with a lens 9 arranged to route a light reaching the protruding element to said passage for the light. Preferably, the lens 9 is arranged on the surface formed at the distal end of the protruding element.

FIG. 4A shows a wristlet object in the form of a watch whose crown 3 is provided with a lens or a mirror 9 arranged at the head of the crown 3. In the watch of FIG. 4B, the crown 3 and the two buttons on either side of the crown comprise a lens and/or a mirror 9. Finally, the watch in FIG. 4C comprises two buttons 4, the free distal end of which is provided with a lens 9. In this embodiment, the crown does not comprise a lens. The lens 9 is also visible in FIGS. 5A and 5B.

In one embodiment, the protruding element is at least partly transparent, for example comprises a transparent material allowing the passage of the light directly through at least a part of the material of the protruding element. The protruding element or a part thereof may in itself operate as a lens or mirror, or as a passage for the light.

The lens can be of any type and of different forms. The lens can be a Fresnel, convex (spherical/aspherical), multifocal or concave lens, planar light guides, networks of microlenses, etc.

Instead of or in addition to the lens, a mirror can be used, arranged on the protruding element in order to enhance the capture of the light and the guidance of the light to the passage of the light and/or to the cell. The mirror or can also be arranged on the aperture in the case forming a light passage.

In the mirror case, the invention envisages the use of a mirror of the solar concentrator type, of concave parabolic mirror type, of Cassegrain configuration optic type, to cite only a few examples.

Preferably, the lens is secured to the protruding element, for example to the crown and/or to the button. In one embodiment, the lens can be dismantled.

Preferably, the mirror is secured to the protruding element, for example to the crown and/or to the button. In one embodiment, the mirror can be dismantled.

The lens and/or the mirror can comprise glass, sapphire glass, crystal glass, quartz, natural stone, plastic material, for example made of acrylic glass (e.g. PMMA, polymethyl methacrylate). Preferably, the lens is made of one of the abovementioned materials.

The lens can be transparent or translucent and/or it may or may not be colored.

One aim of the lens and/or of the mirror is to make the light converge on the photovoltaic cell, in particular on the passage for the light leading to the cell.

In one embodiment, photovoltaic cells can be arranged both on a protruding element and inside the case, on the control center, for example.

For example, photovoltaic cells can be arranged both on a button and inside the case, on the movement. For example, a button can be provided with a lens at the head of the button, and with a cell arranged on the lateral surface of the button.

In one embodiment, photovoltaic cells can be arranged both on the crown and inside the case, on the movement, for example. For example, the crown can be provided with a lens at the head of the crown, and with a cell can be arranged on the lateral surface of the crown.

In the abovementioned scenarios, the shaft linking the protruding element to the control center preferably comprises both the cable or cables necessary to transport the current generated by the cell on the crown/the button to the movement, and also the passage for the light to transport the light into the interior of the case.

In one embodiment (not shown in the drawings), the passage for the light comprises and/or consists essentially of an aperture, for example a hole or a tube in the case. The aperture is preferably arranged to allow the light to pass through a wall of the case and to preferably reach the photovoltaic cell arranged in the wristlet object, for example on the control center and/or on an internal surface of the case. This embodiment is based on the fact that, over a short and linear path, there is no need for an optical fiber to allow the light to reach the cell. In the case of this embodiment, a protruding element and/or the shaft are preferably absent. In this case, the invention is not necessarily associated with a protruding object, such as a button or a crown, and the latter can also be absent.

It should be noted that, when the light passage comprises an aperture in the case, the aperture is preferably closed and/or covered by a transparent, translucent and/or colored material, in order to protect the control center inside the case from dust and other contaminants from the outside. For example, the aperture can be provided with a lens and/or can comprise one or more mirrors as described above in the case of the shaft.

The aperture allowing the light to pass inside the case is preferably arranged in a wall of the case, preferably in the middle of the case. In one embodiment, the aperture is arranged on the dial. In one embodiment, the dial is at least partly transparent, in order to allow the light to reach the control center, for example the movement, on which the cell is arranged.

The invention thus covers all the combinations of the embodiments disclosed in the present description.

A person skilled in the art will have no particular difficulty in adapting the content of the present disclosure to his or her own needs and implementing a movement and/or a wristlet object, without departing from the scope of the present invention.

What is claimed is:

1-10. (canceled)

11. A wristlet object comprising at least one protruding element chosen among a crown and a button, said wristlet object comprising at least one photovoltaic cell,
wherein said at least one photovoltaic cell is arranged at the head of the protruding element, and/or on a lateral surface of the protruding element.

12. The wristlet object as claimed in claim 11, wherein the wristlet object comprises one or more shafts for linking the protruding element to a control center.

13. The wristlet object as claimed in claim 12, wherein the shaft is hollow and/or comprises a tube, and wherein one or more electrical cables is/are guided inside the shaft.

14. The wristlet object as claimed in claim 13, comprising said photovoltaic cell in or on the control center and/or in the case of said wristlet object, wherein said passage for the light is arranged to transport the light which reaches said protruding element to the interior of the control center and/or of the case to said photovoltaic cell arranged on or in said control center or case.

15. The wristlet object as claimed in claim 11, wherein the wristlet object comprises a mirror and/or a lens arranged on said protruding element.

16. The wristlet object as claimed in claim 15, wherein the mirror and/or lens is arranged on the head of said protruding element.

17. The wristlet object as claimed in claim 11, chosen from a wristwatch, a smartwatch, a connected watch, and a wristlet object arranged to measure one or more physiological, medical and/or environmental parameters.

18. The wristlet object as claimed in claim 11, wherein said control center is a movement.

19. The wristlet object as claimed in claim 11, wherein said control center is a watch movement.

20. A control center for a wristlet object chosen from wristwatches, including connected wristwatches, and a wristlet object arranged to measure one or more physiological, medical and/or environmental parameters, the control center being arranged to be housed in a case of the wristlet object, said control center comprising a photovoltaic cell.
